(19) United States
(12) Patent Application Publication
(10) Pub. No.: US 2015/0278721 A1
(43) Pub. Date: Oct. 1, 2015

(54) INFORMATION COLLECTING SYSTEM, INFORMATION COLLECTING METHOD, AND STORAGE MEDIUM

(71) Applicant: smart-FOA, Saitama (JP)

(72) Inventor: Masaharu Oku, Saitama (JP)

(21) Appl. No.: 14/351,947

(22) PCT Filed: Feb. 18, 2014
(86) PCT No.: PCT/JP2014/053788

§ 371 Date: Apr. 15, 2014

(30) Foreign Application Priority Data
Mar. 19, 2013 (JP) 2013-055904
Feb. 14, 2014 (JP) 2014-027017

(51) Int. Cl. G06Q 10/06; G06F 17/30

(52) U.S. Cl. CPC G06Q 10/063; G06F 17/30342; G06F 17/30525

(57) ABSTRACT

A searching unit for searching each supplementary information from a database, and a reconfiguring unit for adding the searched supplementary information to the job-site data and reconfiguring event information for each individual product and each manufacturing process are provided. The searching unit searches for other kinds of supplementary information by various combinations in the job-site data included in the event information reconfigured by the reconfiguring unit and each of the added supplementary information as a search key, and the reconfiguring unit sequentially adds the supplementary information sequentially searched by the searching unit to the event information. Moreover, a tracking information generating unit is provided for generating event tracking information in which each of the event information in each manufacturing process of the same individual product is collected and integrated.

### FIELD OF THE INVENTION

The present invention relates to an information collecting system that collects job-site data generated at a factory, an office and the like.

### BACKGROUND OF THE INVENTION

Various facilities are operated for each manufacturing process in a factory, an office and the like, and these facilities output job-site data upon generation of an event such as an error, process completion and the like. The job-site data is information notifying the generation of the event. This job-site data is outputted as numerical values which are coded or indicate observation results, and reaches an administrator of fixed property with information of a place, time and date of the generation added. The administrator of the fixed property is a person responsible for maintenance and management of the facilities in a factory and a person responsible for facilities such as a server and the like at an office, for example.

This job-site data is important information which contributes to operation management, quality control of products, business management and the like of a factory or an office. However, the event information directly outputted by the facilities has only direct meanings indicating a code or a simple observation value, and place, time and date of the generation and has no secondary or tertiary meanings. Thus, in prior arts, various kinds of information which are useful in interpretation of this job-site data are stored in various databases, and the job-site data and the databases of the various kinds of information are linked with each other. When the job-site data is to be retrieved from the database, if useful information from another database is also retrieved by following the link, it would help analyze what happened at a moment of the generation of the event.

However, only cutting out of the point of time of the generation of the event might not be sufficient for the analysis of the data, and other events before and after the generation of the event need to be considered in a time series. That is, if the information collecting system cannot satisfy traceability of a product having gone through the various manufacturing processes, beneficial conclusions cannot be led by the analysis in some cases.

As an information collecting system seeking traceability, a system in which manufacture data in which individual identification numbers of products or components are associated with manufacturing processes are collected, and upon receipt of a request for traceability, all the manufacture data including the same individual identification number is retrieved is cited (see Patent Literature 1, for example).

### CITATION LIST

### Patent Literature

Patent Literature 1: JP 2007-208187A

### SUMMARY OF THE INVENTION

### Problems to be Solved by the Invention

It is beneficial if traceability information, with which a manufacturing process of a product can be tracked, includes actual production information in each manufacturing process, productivity information in each manufacturing process, quality information in each manufacturing process, past result information or expected trouble information in each manufacturing process. However, since these kinds of information have been stored in the respective specific databases, it has been necessary to construct a new database storing the traceability information and to construct links with the databases respectively storing each of the existing information.

However, each of the databases has different specifications for defining method of information, a communication protocol such as an access method and the like, a type of a server, a difference in a network structure and the like depending on the time, place, and division of introduction. Therefore, it has not been practical to construct a database for the traceability information linked with each of the databases.

According to the technology of Patent Literature 1, when all the manufacture data including the same individual recognition number is to be retrieved, construction of a database in conformity to a retrieving method specific to each database and modification of the database in accordance with any change in the specification of the database after the conformity has not been easy. That is, collecting various kinds of information is not practical after the various kinds of information necessary for the traceability are scattered in various databases, and the technology in Patent Literature 1 lacks effectiveness.

The present invention was proposed in order to solve the above-described problems of the prior-art technologies and has an object to provide an information collecting system which can easily collect supplementary information of various kinds of job-site data and each manufacturing process from a viewpoint of traceability without a need of constructing a link between the databases.

### Solution to Problem

In order to achieve the above-described object, an information collecting system according to the present invention is an information collecting system connected to each of data generating apparatuses which generates job-site data of each manufacturing process for each individual product via a network, including a first storage which storing a dictionary defining a type of each supplementary information to be added to the job-site data, a database which stores the supplementary information having various contents, a searching unit which searches for each of the supplementary information from the database in accordance with the dictionary, a reconfiguring unit which adds each of the searched supplementary information to the job-site data and reconfigures event information of each individual product and each manufacturing process, and a second storage accumulating the event information, wherein the searching unit makes the search for the supplementary information by using a combination according to a type defined in the dictionary in the job-site data included in the event information reconfigured by the reconfiguring unit and each of the added supplementary information as a search key, the reconfiguring unit sequentially adds the supplementary information sequentially searched by the searching unit, and a tracking information generating unit is further provided which generates event tracking information in which each of event information occurring on each manufacturing process producing the same individual product is collected from the second storage and integrated.

A third storage may be further provided for storing type information of the event information to be integrated into the event tracking information, and the tracking information generating unit may collect the event information indicated by the type information stored in the third storage from the second storage and integrate it.

The dictionary stored by the first storage may be so configured that a type indicating individual identification information of a component or a material used in a product in a manufacturing process from which the event information originates is defined as supplementary information to be added to the job-site data, the reconfiguring unit adds the individual identification information to the event information, and the tracking information generating unit repeats collection of the event information by using the individual identification information as a search key and collection of the event information by using the individual identification information similarly included in the collected event information as the search key and collects each of the event information of each manufacturing process of the same individual product.

The third storage may store the type information of the event information having the same individual identification information in association by a link, and the tracking information generating unit may specify the type information of the event information to be subsequently collected by following the link and collect the event information to be subsequently collected by using the same individual identification information as a search key.

The second storage may store the event information for each of the type information, and the tracking information generating unit may use only the event information corresponding to the specified type information as a search target.

A display unit which displays a display screen for selecting the type information to be stored in the third storage and an operating unit for operating the display screen may be further provided.

In order to achieve the above-described object, an information collecting method according to the present invention is an information collecting method of an information collecting system connected to each of data generating apparatuses which generates job-site data of each manufacturing process for each individual product via a network, the information collecting system including a first storage storing a dictionary defining a type of each of supplementary information to be added to the job-site data, a database which stores the supplementary information having various contents, and a second storage, a searching step of searching for each of the supplementary information from the database in accordance with the dictionary, an event information generating step of adding each of the searched supplementary information to the job-site data and reconfiguring event information of each individual product and each manufacturing process, and a storing step of accumulating the event information in the second storage are executed, in the searching step, a search is made for the supplementary information by using a combination according to a type defined in the dictionary in the job-site data included in the event information reconfigured in the event information generating step and each of the added supplementary information as a search key, in the event information generating step, the supplementary information sequentially searched by the searching unit is sequentially added to the event information, and a tracking information generation step of generating event tracking information in which each of the event information of each manufacturing process of the same individual product is collected from the storage and integrated is further executed.

The information collecting system may be further provided with a third storage which stores type information of the event information to be integrated into the event tracking information, and the tracking information generating step may collect the event information indicated by the type information stored in the third storage from the second storage and integrate it.

It may be so configured that, in the dictionary stored in the first storage, the type indicating the individual identification information of a component or a material used in a product in the manufacturing process from which the event information originates is defined as the supplementary information to be added to the job-site data, in the event information generating step, the individual identification information is added to the event information, and in the tracking information generating step, collection of the event information by using the individual identification information as a search key and collection of the event information by using the individual identification information similarly included in the collected event information as the search key are repeated so as to collect each of the event information of each manufacturing process of the same individual product.

The third storage may store the type information of the event information having the same individual identification information in association by a link, and the tracking information generating step may specify the type information of the event information to be subsequently collected by following the link and collect the event information to be subsequently collected by using the same individual identification information as a search key.

The second storage may store the event information for each of the type information, and the tracking information generating step may use only the event information corresponding to the specified type information as a search target.

A display screen for selecting the type information to be stored in the third storage may be displayed on the display screen, and the type information may be stored in the third storage in accordance with an operation on the display screen.

In order to achieve the above-described object, a storage medium according to the present invention allows an information collecting system connected to each of data generating apparatuses which generates job-site data of each manufacturing process for each individual product via a network and including a first storage which stores a dictionary defining a type of each of supplementary information to be added to the job-site data, a database which stores the supplementary information having various contents, and a second storage, to execute a searching step of searching each of the supplementary information from the database in accordance with the dictionary, an event information generating step of adding each of the searched supplementary information to the job-site data and reconfiguring event information of each individual product and each manufacturing process, and a storing step of accumulating the event information in the second storage, in the searching step, a search is made for the supplementary information by using a combination according to a type defined in the dictionary in the job-site data included in the event information reconfigured in the event information generating step and each of the added supplementary information as a search key, in the event information generating step, the supplementary information sequentially searched by the searching unit is sequentially added to the event information, and a tracking information generating step of generating the event tracking information in which each of the event information of each manufacturing process of the same individual product is collected from the storage and integrated is further executed.

The information collecting system may be further provided with a third storage which stores type information of the event information to be integrated into the event tracking information, and the tracking information generating step may collect the event information indicated by the type information stored in the third storage from the second storage and integrate it.

In the dictionary stored in the first storage, the type indicating the individual identification information of a component or a material used in a product in the manufacturing process from which the event information originates is defined as the supplementary information to be added to the job-site data, in the event information generating step, the individual identification information is added to the event information, and in the tracking information generating step, collection of the event information by using the individual identification information as a search key and collection of the event information by using the individual identification information similarly included in the collected event information as the search key may be repeated so as to collect each of the event information of each manufacturing process of the same individual product.

The third storage may store the type information of the event information having the same individual identification information in association by a link, and the tracking information generating step may specify the type information of the event information to be subsequently collected by following the link and collect the event information to be subsequently collected by using the same individual identification information as a search key.

The second storage may store the event information for each of the type information, and the tracking information generating step may use only the event information corresponding to the specified type information as a search target.

A display screen for selecting the type information to be stored in the third storage may be displayed on a display screen and the type information may be stored in the third storage in accordance with an operation on the display screen.

### Advantages of the Invention

According to the present invention, there is no need to construct a link between the databases for generating event information by using each of the databases and further for generating event tracking information, and various kinds of job-site data and the supplementary information of each manufacturing process can be collected easily from a viewpoint of traceability.

### BRIEF DESCRIPTION OF THE DRAWINGS

FIG. 1 is a block diagram illustrating a network configuration including an information collecting system according to a first embodiment.

FIG. 2 is a schematic diagram illustrating job-site data.

FIG. 3 is a schematic diagram illustrating a database.

FIG. 4 is a schematic diagram illustrating event information.

FIG. 5 is a schematic diagram illustrating event tracking information.

FIG. 6 is a block diagram illustrating a configuration of the information collecting system according to the first embodiment.

FIG. 7 is a schematic diagram illustrating a dictionary.

FIG. 8 is an explanatory diagram illustrating a reconfiguring mode of the event information.

FIG. 9 is an explanatory diagram illustrating a generation process of event tracking information.

FIG. 10 is a flowchart illustrating an operation from generation of the job-site data to generation of the event information.

FIG. 11 is a flowchart illustrating an operation from the event information to generation of the event tracking information.

FIG. 12 is a schematic diagram illustrating a specific mode of generation of the job-site data.

FIG. 13 is a schematic diagram illustrating a specific mode of generation of the event information.

FIG. 14 is a schematic diagram illustrating a specific mode of generation of the event tracking information.

FIGS. 15A and 15B are conceptual diagrams of information collecting methods by a prior-art information collecting system and the information collecting system of this embodiment.

FIG. 16 is a block diagram illustrating a configuration of an information collecting system according to a second embodiment.

FIG. 17 is a schematic diagram illustrating system information.

FIG. 18 is a schematic diagram illustrating first transition of an operation screen displayed at generation of the system information.

FIG. 19 is a schematic diagram illustrating second transition of an operation screen displayed at generation of the system information.

FIG. 20 is a schematic diagram illustrating a temporary memory according to the second embodiment.

FIG. 21 is a flowchart relating to the second embodiment and illustrating an acquiring operation of the event information which becomes a start point.

FIG. 22 is a flowchart relating to the second embodiment and illustrating the acquiring operation of the event information.

### DETAILED DESCRIPTION OF THE EMBODIMENTS

### First Embodiment

### Entire Configuration

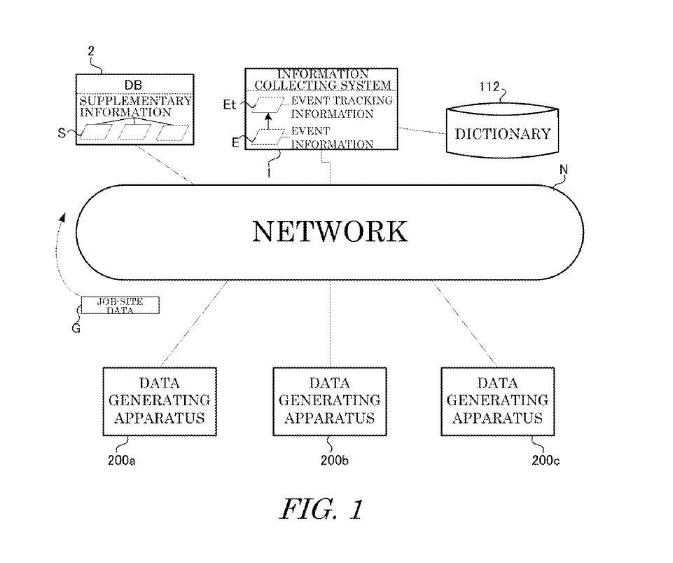

FIG. 1 is a block diagram illustrating a network configuration including an information collecting system according to a first embodiment. The information collecting system 1 is connected to a network N. To the network N, one or more data generating apparatuses 200a, 200b, 200c, . . . and a database 2 are connected. The information collecting system 1, the database 2, and the data generating apparatus 200 are configured by including a computer and is provided with a central processing unit (CPU), a main storage device (RAM), and an external storage device (HDD and the like) storing OS and an information collecting application, and a network adapter. The information collecting system 1 is a single computer or a group of distributed computers. Moreover, the information collecting system 1 and the database 2 are an integrated computer or separate computers distributed over the network N.

The information collecting application is a program code or a control program causing the computer to function as the information collecting system 1 and is specifically an object code or a machine language instruction. This program code or control program may be written in various source code program languages and then stored in a mode complied or assembled into an executable machine code or an instruction suitable for the central processing unit. This application is stored in a portable storage medium such as a CDROM, DVDROM or USB memory and the like or a storage medium on the network such as a server and the like and installed in the external storage device. The computer configuring the information collecting system 1 has a drive capable of reading the portable storage medium and connected to a network capable of accessing the storage medium on the network such as a server and the like.

The data generating apparatuses 200a, 200b, 200c, . . . are manufacturing facilities and installed for each manufacturing process. This data generating apparatus 200 is an FA or the like operating in a factory or an office, for example, and is provided with a computer. The computer is built in the FA or the like or a separate body such as a programmable logic controller or the like and connected to the network.

Assume that, for example, a manufacturing process of a product goes through a receiving process of a component or a material, an assembly or processing process of the component, a sub-assembly process of each sub-assembly, an assembly process of an end product, an inspection process of the end product, and a warehousing process of the end product. At this time, the data generating apparatuses 200a, 200b, 200c, . . . are a manufacturing facility of the receiving process, the manufacturing facility of the processing process, the manufacturing facility of the sub-assembly process, the manufacturing facility of the assembly process, the manufacturing facility of the inspection process, and the manufacturing facility of the warehousing process.

The network N is a network conforming to a wired communication protocol such as IEEE802.3 and the like, wireless communication protocol prescribed by IEEE802.11 and other protocols and a wired LAN network, a wireless LAN network, the Internet network, a communication line such as a dedicated line or a complex of them.

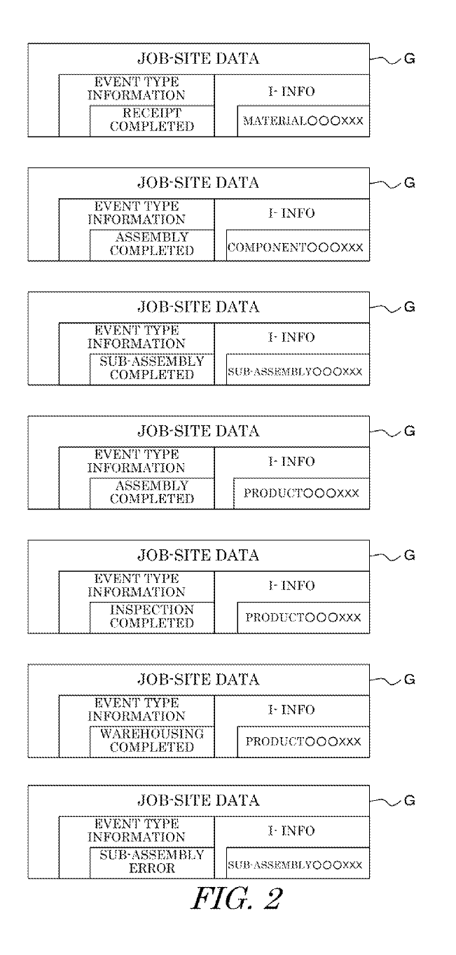

In this network N, each of the data generating apparatuses 200 generates job-site data G. The job-site data G illustrated in FIG. 2 is information notifying generation and an entity of an event in the manufacturing process. The job-site data G is generated for each manufacturing process, for each event type, and for each individual product which is the entity of the event. The generation of the event is specified by detection of various phenomena by a sensor provided in the facility or end of a sequence, and the type of the event is specified by the detection contents or the ended sequence. Then, the data generating apparatus 200 generates the job-site data G gathering event type information and individual identification information upon generation of the event as a trigger.

The event type information indicates the manufacturing process and the type of the event and includes manufacturing process specifying information, error information, and process completion information. The individual identification information specifies the entity of the event and is determined by the manufacturing process and is identification information specific to each individual product, component, material, and sub-assembly of the product.

For example, each of the data generating apparatuses 200 outputs the job-site data G including the individual identification information of the component or the material and the event type information indicating completion of receipt, the job-site data G including the individual identification information of the component or the material and the event type information indicating completion of assembling or processing of the component, the job-site data G including the event type information indicating completion of sub-assembling of each sub-assembly and the individual identification information of the component or material as the basis and the sub assembly, the job-site data G including the event type information indicating completion of assembling of the end product and the individual identification information of the sub-assembly as the basis and the end product, the job-site data G including the individual identification information of the end product and the event type information indicating completion of inspection of the end product, and the job-site data G including the individual identification information of the end product and the event type information indicating completion of warehousing of the end product.

Moreover, for example, the job-site data G including the individual identification information of the sub-assembly on which a sub-assembly work is being performed and the event type information indicating a fatal error that the process subsequent to the work should not be continued is outputted.

This job-site data G might be inputted by a user. The user connects a mobile terminal to the facility provided in the data generating apparatus 200 and inputs the job-site data G by using the mobile terminal as a user interface.

The data generating apparatus 200 adds attribute data to the job-site data G and then, adds a header of TCP or IP including an IP address of the information collecting system 1 and a port number of the information collecting application to the job-site data G and sends it out to the network N. The attribute data is information for specifying a fact of the generation of the job-site data G. Specifically, the attribute data is time and date of the generation and identification information of the data generating apparatus 200.

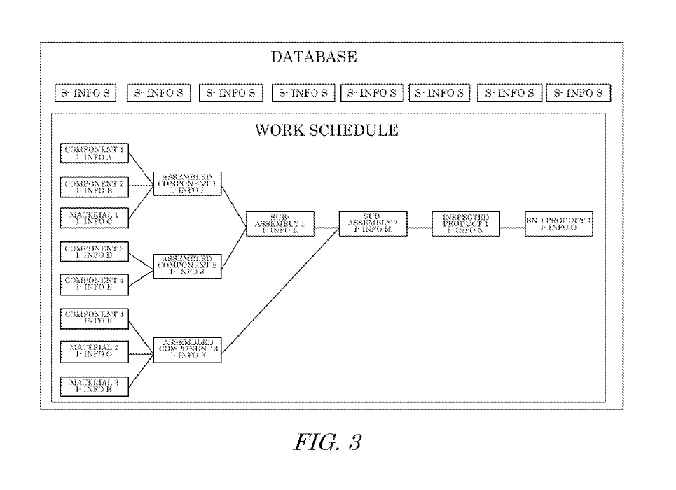

The database 2 may be a database for in-house use only or may be a group of servers made public on the Internet. This database 2 stores supplementary information S having various contents as illustrated in FIG. 3. The supplementary information S is information supporting the contents of the job-site data G and information showing a cause of generation of the job-site data G, background information showing meanings and contents that cannot be derived only from an observation result or attribute data in combination with the job-site data G, explanatory information, analysis information or other various types of useful information.

Specifically, the supplementary information S includes individual identification information indicating a constituent element of the product, processing supporting material information required for processing of the job-site data G, comparison-target material information to be compared with the job-site data G, analysis supporting material information affecting analysis, and evaluation supporting material information affecting an evaluation of an analysis result. Particularly, the database 2 stores actual production information in each manufacturing process, productivity information in each manufacturing process, quality information in each manufacturing process or past result information or expected trouble information in each manufacturing process from the viewpoint of traceability.

Moreover, the database 2 stores individual identification information indicating a constituent element used in a product manufactured in each manufacturing process from a viewpoint of traceability as the supplementary information S. The individual identification information is stored in a gathered form of production schedules in the database 2. The production schedule is an assembly list of the end product to which the individual identification information of the end product, the individual identification information of the sub-assembly to be assembled to the end product, the individual identification information of the component to be assembled to the sub-assembly, and the individual identification information of material used for manufacture of the end product, the sub-assembly, and the component are linked.

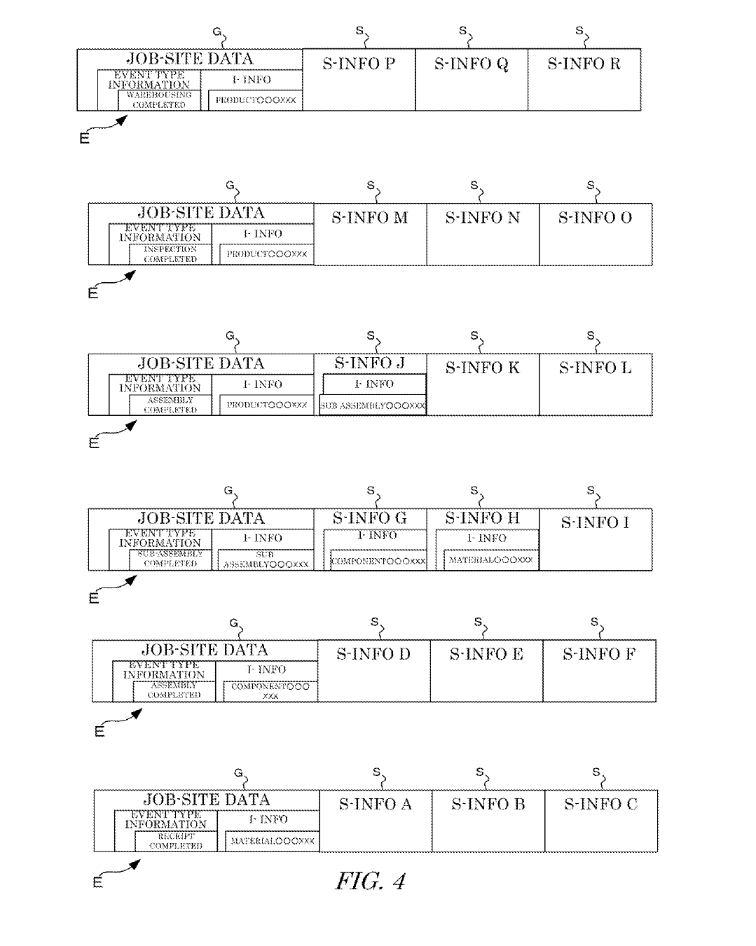

The information collecting system 1 generates event information E using the job-site data G outputted by the data generating apparatuses 200a, 200b, 200c, and the supplementary information S stored in the database 2. As illustrated in FIG. 4, the event information E is data in which the job-side data G and various types of supplementary information S are aligned. In the event information E, the supplementary information S specific to each event type information is aligned. From the viewpoint of traceability of the product, one or more supplementary information S, that is, actual production information, productivity information, quality information, and trouble information in the manufacturing process indicated by the event type information are aligned. Moreover, if there is any sub-assembly, component or material used in the manufacturing process indicated by the event type information, the individual identification information thereof is aligned.

Specifically, the information collecting system 1 searches the database 2 as a database management system (DBMS), retrieves various types of the supplementary information S from the database 2 or retrieves the individual identification information as the supplementary information S from the work schedule and adds it to the received job-site data G so as to construct the event information E.

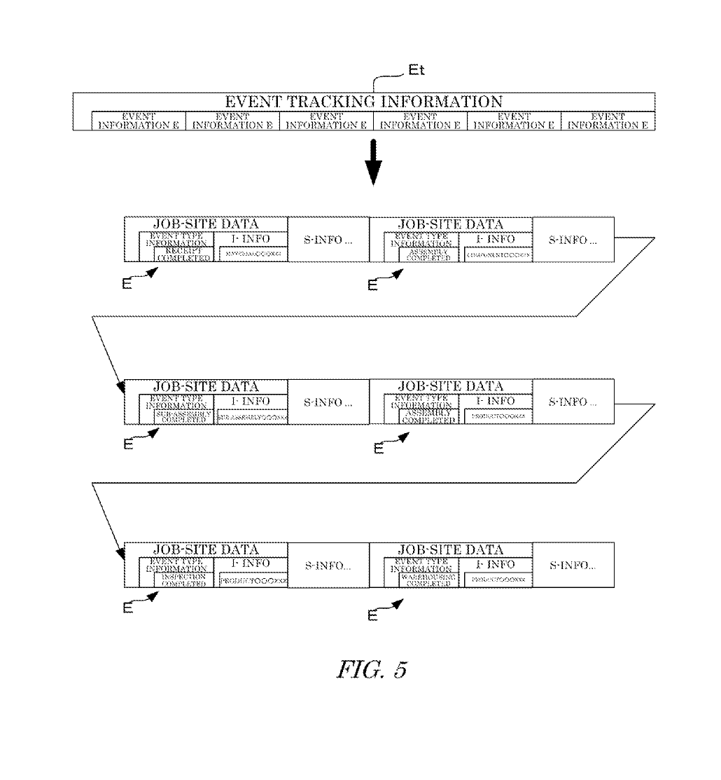

Moreover, the information collecting system. 1 constructs event tracking information Et from the event information E. As illustrated in FIG. 5, the event tracking information Et is a bundle of a plurality of pieces of the event information E, and by joining the event information E from the viewpoint of traceability of the individual product, each event information E for each manufacturing process is integrated by the unit of individual product. This event tracking information Et has a variable length and is big data not having a special data structure.

That is, in the event tracking information Et, the event information E relating to the end product for each individual product and the event information E of each manufacturing process with the sub-assembly, material, and component as the basis of the individual product as entities are gathered. The end product includes not only the product of the last manufacturing process having successfully finished with all the manufacturing processes but also the product leaving the manufacturing process at a fatal error as a trigger.

(System Configuration)

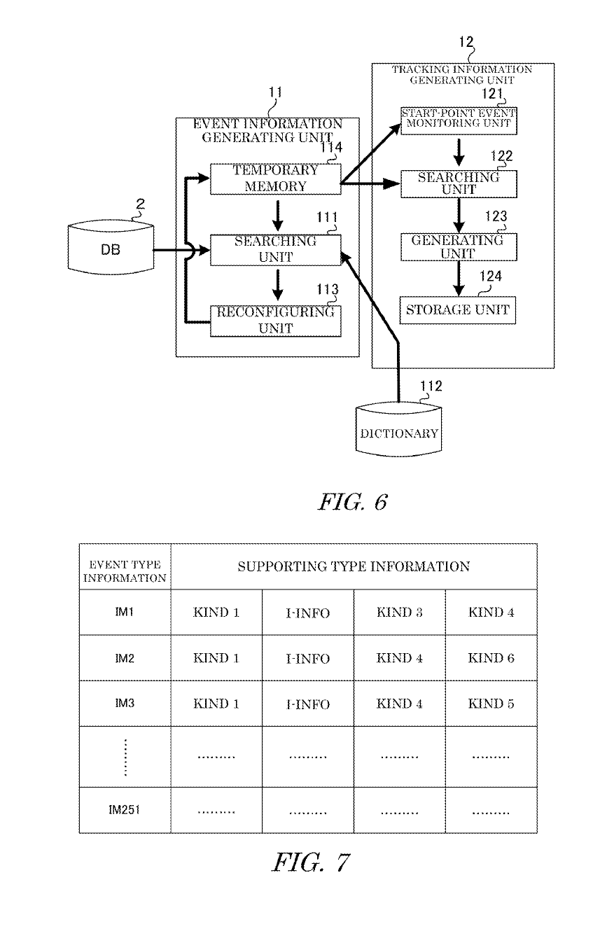

FIG. 6 is a block diagram illustrating a configuration of functions of this information collecting system 1. The information collecting system 1 is provided with an event information generating unit 11 and a tracking information generating unit 12 by the information collecting application stored in the external storage device. The event information generating unit 11 generates the event information E, and the tracking information generating unit 12 generates the event tracking information Et. The event information generating unit 11 is provided with a searching unit 111, a dictionary storage unit 112, a reconfiguring unit 113, and a temporary memory 114. The tracking information generating unit 12 is provided with a start-point event monitoring unit 121, a searching unit 122, a generating unit 123, and a storage unit 124.

(Generation of Event Information E)

The searching unit 111 includes a CPU. This searching unit 111 searches for the supplementary information S from the database 2 by referring to the dictionary stored in the dictionary storage unit 112. The reconfiguring unit 113 includes the CPU. This reconfiguring unit 113 generates the event information E by adding the searched supplementary information S to the job-site data G and then, adds the newly searched supplementary information S to the event information E and sequentially reconfigures the event information E. The temporary memory 114 includes a RAM. This temporary memory 114 temporarily stores the reconfigured event information E.

Here, the dictionary stored in the dictionary storage unit 112 will be described. FIG. 7 is a schematic diagram illustrating the dictionary stored in the dictionary storage unit 112. The dictionary stores various models of the event information E. Each model is prepared for each of event type information, that is, each combination of the manufacturing process and the event type.

Supplementary type information defining the type of the supplementary information S is described in the model. The supplementary type information defines the type of the supplementary information S suitable for the combination of the manufacturing process and the type of the event. In each of the models, one of the supplementary type information means code type information indicating the type of the individual identification information. That is, the event type information and the supplementary type information are described in association with each other in each of the models, and one of the supplementary type information is the code type information.

Upon receipt of the job-site data G, the searching unit 111 searches for the model defined by the manufacturing process and the event type information specified by the job-site data G from the dictionary. Then, it searches the supplementary information S indicated by the supplementary type information remunerated in the model from the database 2.

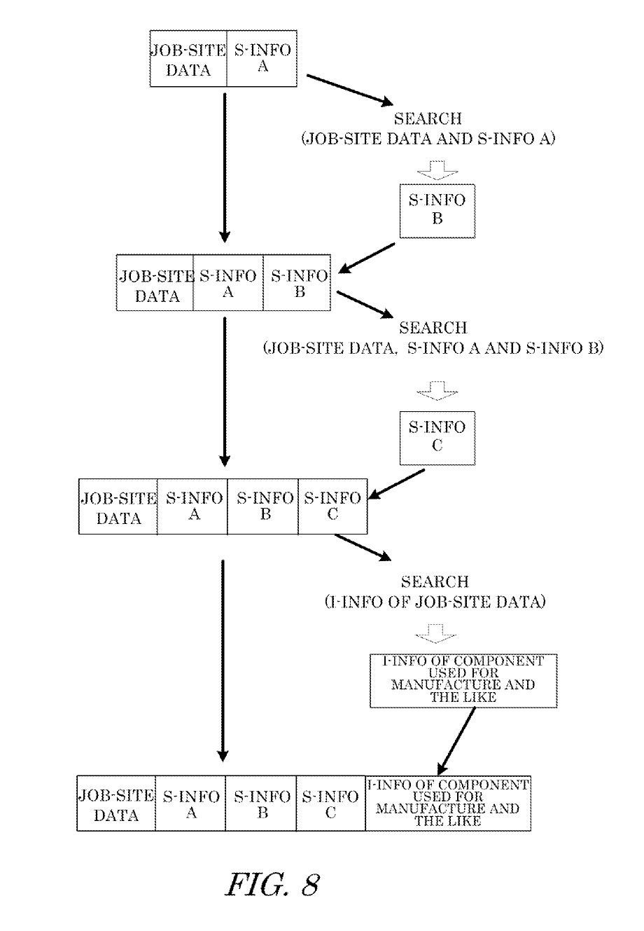

Subsequently, FIG. 8 is an explanatory diagram indicating a reconfiguration mode of the event information E. The searching unit 111 searches for the supplementary information S of another type from the database 2 by using the contents of the job-site data G included in the event information E and the contents of the already added supplementary information S as a search key in the search for the supplementary information S. The searching unit 111 stores types of the search key according to the supplementary type information and combinations in advance as search query information and acquires those search keys from the job-site data G included in the event information E and the supplementary information S and makes AND search of the database 2.

The reconfiguring unit 113 adds the supplementary information S acquired by the search by the searching unit 111 to a data frame of the event information E. In other words, various types of information supporting the job-site data G is sequentially added to the event information E and the various search keys for searching for another supplementary information S are also sequentially added.

For example, in a search for the supplementary information S of a type B indicated by the supplementary type information included in the model acquired from the dictionary, the searching unit 111 reads the job-site data G and contents of attribute data of a type A, makes AND search in the database 2 and as a result, acquires the supplementary information S with contents B1 relating to the type B. The reconfiguring unit 113 adds the newly acquired supplementary information S to the job-site data G and generates the event information E.

Moreover, in a search for the supplementary information S of a type C indicated by the supplementary type information included in the model acquired from the dictionary, the searching unit 111 reads the job-site data G and contents of the attribute data of the type A and the supplementary information S of the type B from the previously generated event information E, makes AND search in the database 2, and as a result, acquires the supplementary information S with contents Cl relating to the type C. The reconfiguring unit 113 adds this newly acquired supplementary information S to the event information E and reconfigures the event information E.

Moreover, if there is any sub-assembly, component or material used in the manufacturing process from which the event information E originates, the searching unit 111 also adds the individual identification information of the sub-assembly, component, or material thereof. That is, if the supplementary type information included in the model acquired from the dictionary is the individual identification information, the searching unit 111 searches a work schedule of the database 2 by using the individual identification information as a search key from the job-site data G.

If there is individual identification information directly linked to the search key on the work schedule, the individual identification information is acquired. Check of the presence and acquisition are made for the individual identification information of a product manufactured in an upper manufacturing process than the product specified by the individual identification information used as the search key.

For example, assume that the job-site data G is generated upon completion of sub-assembly as a trigger. Moreover, assume that two types of components and one type of material are combined to form a sub-assembly. At this time, in the work schedule, the individual identification information of the two types of components and the one type of material is directly linked to the individual identification information of the sub-assembly. The searching unit 111 reads the individual identification information of the sub-assembly from the job-site data G, searches for the read individual identification information in the work schedule, and acquires all the individual identification information directly linked to the applicable individual identification information.

As a searching method of the database 2, not only the AND search but various methods can be used. For example, ambiguous search and the like may be used. The ambiguous search is also referred to as semantic search and is a method for making a search from meanings and contents of the search key. Moreover, if the database 2 is a server made public, this searching unit 111 may be a query retrieve client requesting a search engine accessible via the Internet to make a search.

(Generation of Event Tracking Information Et)

The start-point event monitoring unit 121 mainly includes a CPU. First, the event information E to be included in the event tracking information Et is collected by following the individual identification information, but the start-point event monitoring unit 121 monitors generation of the event information E which becomes the start point. A place for monitoring by the start-point event monitoring unit 121 is the temporary memory 114, and a target of monitoring is the event information E having completion of the last process of manufacture or a fatal error as the event type information.

When the event information E is stored in the temporary memory 114, the start-point event monitoring unit 121 reads the job-site data G of the event information E and determines whether the job-site data G is a specific type or not. That is, the event type information included in the event information E is referred to, and it is determined whether or not the event type information is completion of the last process or a fatal error.

The searching unit 122 mainly includes a CPU and searches the event information E of the same individual generated in the manufacturing process before the event information E detected by the start-point event monitoring unit 121 by sequentially following to the first manufacturing process. The generating unit 123 mainly includes a CPU and integrates the event information E searched by the searching unit 122 and sequentially generates the event tracking information Et. The storage unit 124 includes the external storage device such as a HDD and the like and stores the event tracking information Et generated by the generating unit 123.

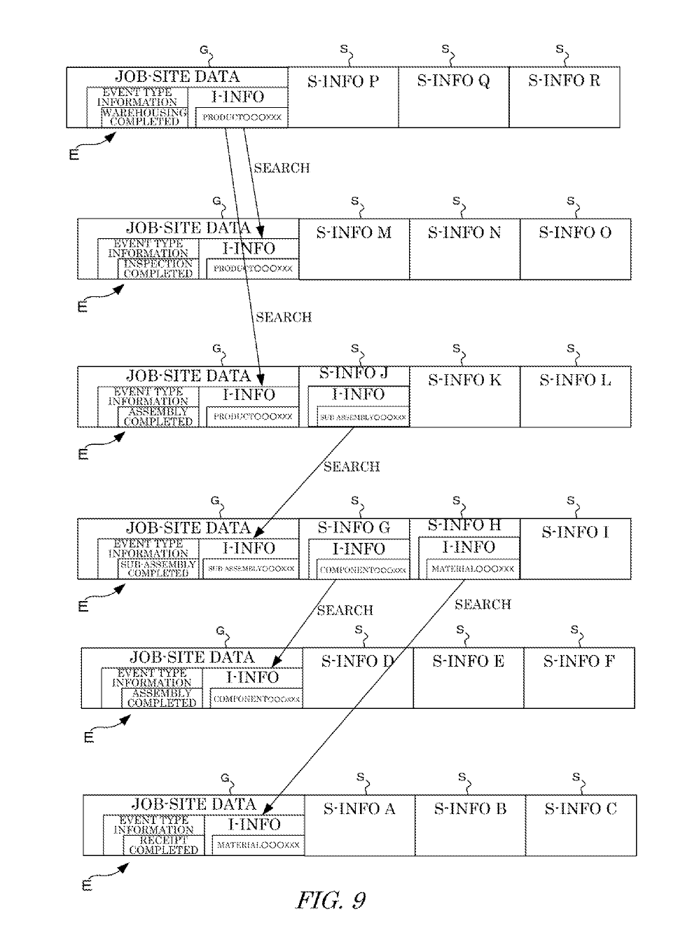

FIG. 9 is an explanatory diagram illustrating a generation process of the event tracking information Et. By using the individual identification information included in the event information E detected by the start-point event monitoring unit 121 as a search key, the searching unit 122 searches for the event information E stored in the temporary memory 114. When the applicable event information E is found, by using the individual identification information included in the event information E as a search key, a search for the subsequent event information E is repeated. When the event information E is searched for by the searching unit 122, the generating unit 123 sequentially includes the event information E in the data frame of the event tracking information Et.

When a plurality of pieces of the individual identification information are included in the event information E, the plurality of pieces of individual identification information are handled as search keys, respectively, and search processing is executed. When the plurality of pieces of event information are searched at the same time, the individual identification information included in the plurality of pieces of event information E is handled as a search key, respectively, and search processing is executed.

Each event information E includes the individual identification information indicating the sub-assembly, the component, and the material used by the event information generating unit 11 in the manufacturing process from which the event information E originates. Thus, by means of the tracking information generating unit 12, the event information E generated from the beginning of the manufacture to the last process until manufacture of the end product is completed is collected and integrated into the event tracking information Et.

(Operation)

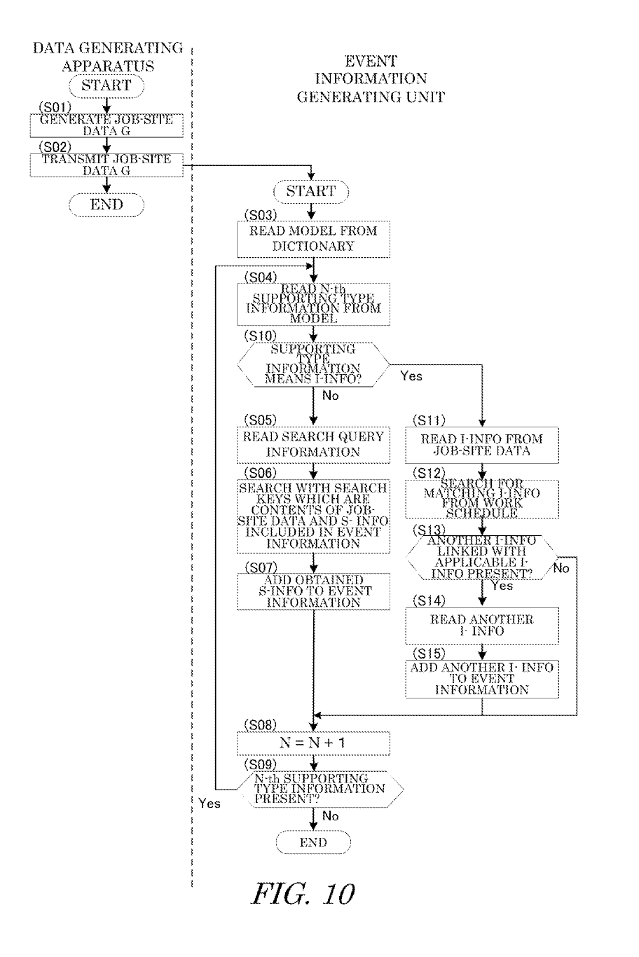

An operation of such information collecting system 1 will be explained. FIG. 10 is a flowchart illustrating the operation from generation of the job-site data G to the generation of the event information E. As illustrated in FIG. 10, when the job-site data G is generated in the data generating apparatus 200 (Step S01), the data generating apparatus 200 transmits the job-site data G to the information collecting system 1 (Step S02). In the information collecting system 1, the searching unit 111 of the event information generating unit 11 reads the model matching the event type information having been added to the job-site data G from the dictionary of the dictionary storage unit 112 (Step S03).

When the model is read, the searching unit 111 reads the N-th supplementary type information from the model (Step S04), reads a search key type from search query information associated with the supplementary type information (Step S05), reads the job-site data G and contents of each supplementary information S applicable to the search key type from the event information E and searches the database 2 by using the read job-site data G and the contents of each supplementary information S as a search key of AND search (Step S06). If the supplementary information S is acquired as the result of the search, the reconfiguring unit 113 reconfigures the event information E to which the acquired supplementary information S is added (Step S07).

Here, the supplementary type information is read (Step S04), and if the read supplementary type information is the individual identification information (Step S10, Yes), the searching unit 111 reads the individual identification information from the job-site data G (Step S11) and searches for the matching individual identification information from the work schedule (Step S12). If another individual identification information is directly linked to the applicable individual identification information (Step S13, Yes), another individual identification information is read (Step S14). The reconfiguring unit 113 reconfigures the event information E to which the read another individual identification information is added as the supplementary information S (Step S15).

Assuming that N=N+1 (Step S08), if there is the N-th supplementary type information in the model (Step S09, Yes), the searching unit 111 returns to Step S04 and repeats the search. On the other hand, if the search has been finished for all the supporting type information (Step 09, No), the search processing is finished.

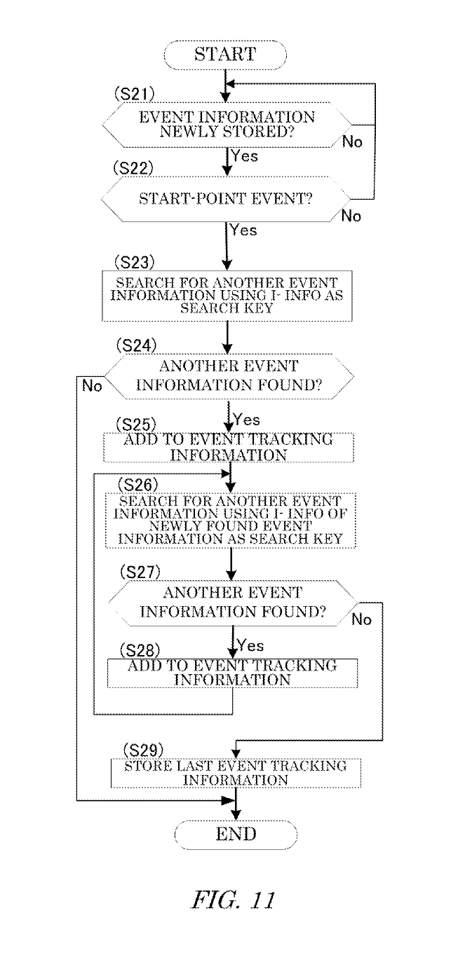

FIG. 11 is a flowchart illustrating an operation from the event information E to generation of the event tracking information Et. When new event information E is stored in the temporary memory 114 (Step S21, Yes), the start-point event monitoring unit 121 of the tracking information generating unit 12 determines whether the newly stored event information E includes event type information indicating the last manufacturing process or a fatal error (Step S22). The determination by the start-point event monitoring unit 121 is repeated at each generation of the new event information E.

When the start-point event monitoring unit 121 confirms generation of the event information E (Step S22, Yes), the searching unit 122 searches for another event information E from the temporary memory 114 (Step S23) by using the individual identification information included in the event information E as a search key. If another event information E is found (Step S24, Yes), the generating unit 123 aligns the event information E detected by the start-point event monitoring unit 121 and the event information E searched for by the searching unit 122 and generates event tracking information Et which is a series of data (Step S25).

Moreover, the searching unit 122 searches still another event information E from the temporary memory 114 by using the individual identification information included in the newly found event information E as a search key (Step S26). If still another event information E is found (Step S27, Yes), the generating unit 123 further adds the event information E to the event tracking information Et (Step S28). As long as another event information E is found, Steps S26 to S28 are repeated. On the other hand, if applicable event information E is not found as the result of the search (Step S27, No), generation of the event tracking information Et is finished and stored in the storage unit 124 (Step S29).

(Action)

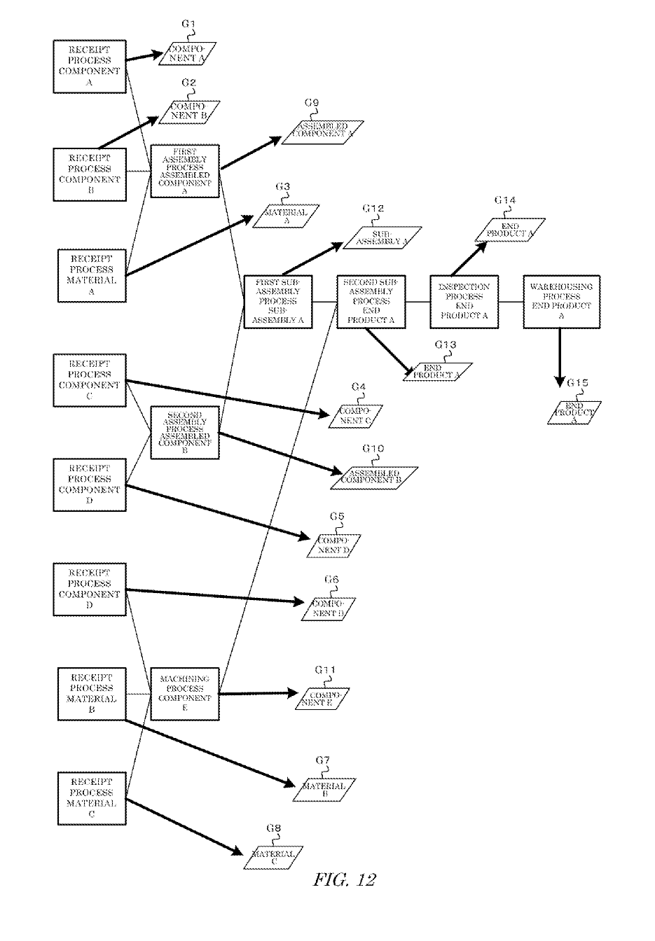

A specific example of generation of the event tracking information Et by the information collecting system 1 will be cited. As illustrated in FIG. 12, assume that an end product A is manufactured from components A to D and materials A to C. And its manufacturing process is assumed to be composed of a receipt process of each of the components A to D and the materials A to C, a first assembly process of acquiring an assembled component A by assembling components A and B by using the material A, a second assembly process of acquiring an assembled component B by assembling the components C and D, a machining process of acquiring a component E by machining the component D by using the materials B and C, a first sub-assembly process of acquiring a sub-assembly A by sub-assembling the assembled components A and B, a second sub-assembly process of acquiring an end product A by sub-assembling the sub-assembly A and the component E, an inspection process of inspecting the end product A, and a warehousing process of warehousing the inspected end product A into a warehouse.

Each of the receipt process, the first assembly process, the second assembly process, the machining process, the first sub-assembly process, the second sub-assembly process, the inspection process, and the warehousing process is successfully completed, job-site data G1 to G15 including process completion in each process as event type information are generated. Since the job-site data G1 to G15 are logical data, it is not affected by a change at a job site such as a line change.

This job-site data G1 includes the event type information indicating completion of receipt of the component A and the individual identification information of the component A. The job-site data G2 includes the event type information indicating completion of receipt of the component B and the individual identification information of the component B. The job-site data G3 includes the event type information indicating completion of receipt of the material A and the individual identification information of the material A. The job-site data G4 includes the event type information indicating completion of receipt of the component C and the individual identification information of the component C. The job-site data G5 includes the event type information indicating completion of receipt of the component D and the individual identification information of the component D. The job-site data G6 includes the event type information indicating completion of receipt of the component D and the individual identification information of the component D. The job-site data G7 includes the event type information indicating completion of receipt of the material B and the individual identification information of the material B. The job-site data G8 includes the event type information indicating completion of receipt of the material C and the individual identification information of the material C.

Moreover, the job-site data G9 includes the event type information indicating completion of assembly of the assembled component A and the individual identification information of the assembled component A. Moreover, the job-site data G10 includes the event type information indicating completion of assembly of the assembled component B and the individual identification information of the assembled component B. Moreover, the job-site data G11 includes the event type information indicating completion of machining of the component E and the individual identification information of the component E.

Furthermore, the job-site data G12 includes the event type information indicating completion of sub-assembly of the sub-assembly A and the individual identification information of the sub-assembly A. The job-site data G13 includes the event type information indicating completion of manufacture of the end product A and the individual identification information of the end-product A.

The job-site data G14 includes the event type information indicating completion of inspection of the end product A and the individual identification information of the end product A. Lastly, the job-site data G15 includes the event type information indicating completion of warehousing of the end product A and the individual identification information of the end product A.

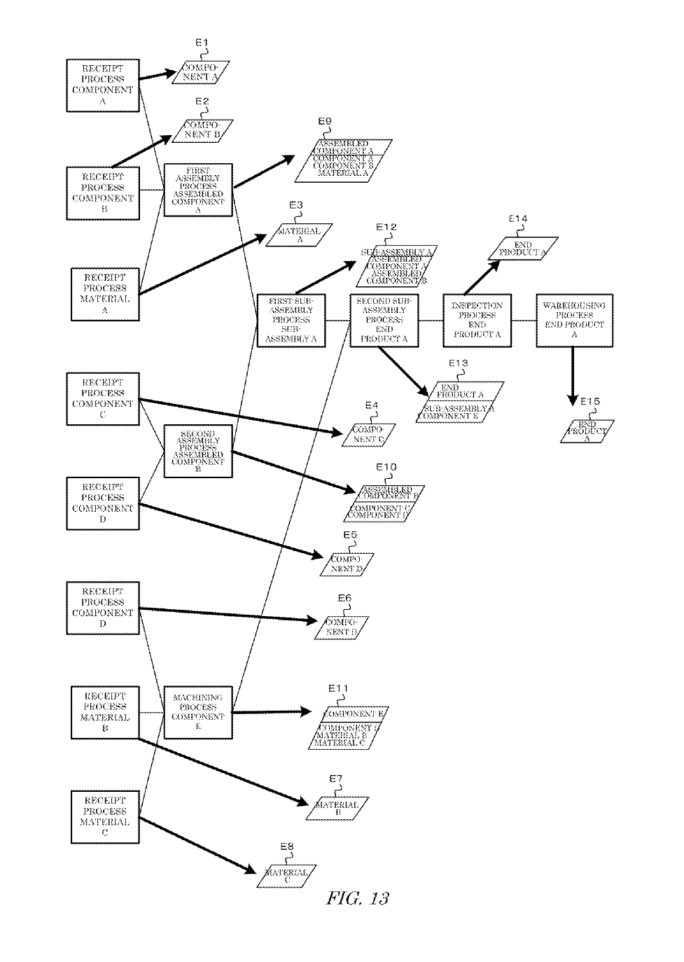

The job-site data G1 to G15 are reconfigured by the event information generating unit 11 into the event information E1 to E15 as illustrated in FIG. 13. At this time, each of the event information E1 to E15 has actual production information, productivity information, quality information, and trouble information suitable for the manufacturing process from which the event originates added as the supplementary information S.

Moreover, to the event information E9 originating from the first assembly process, other than the individual identification information of the assembled component A held by the job-site data G9, the individual identification information of the component A, the component B, and the material A used in the first assembly process is added as the supplementary information S by referring to the work schedule.

Moreover, to the event information E10 originating from the second assembly process, other than the individual identification information of the assembled component B held by the job-site data G10, the individual identification information of the component C and the component D used in the second assembly process is added as the supplementary information S by referring to the work schedule.

Moreover, to the event information E11 originating from the machining process, other than the individual identification information of the component E held by the job-site data G11, the individual identification information of the component D, the material B, and the material C used in the machining process is added as the supplementary information S by referring to the work schedule.

Moreover, to the event information E12 originating from the first sub-assembly process, other than the individual identification information of the sub-assembly A held by the job-site data G12, the individual identification information of the assembled component A and the assembled component Bused in the first sub-assembly process is added as the supplementary information S by referring to the work schedule.

Furthermore, to the event information E13 originating from the second sub-assembly process, other than the individual identification information of the end product A held by the job-site data G13, the individual identification information of the sub-assembly A and the component E used in the second sub-assembly process is added as the supplementary information S by referring to the work schedule.

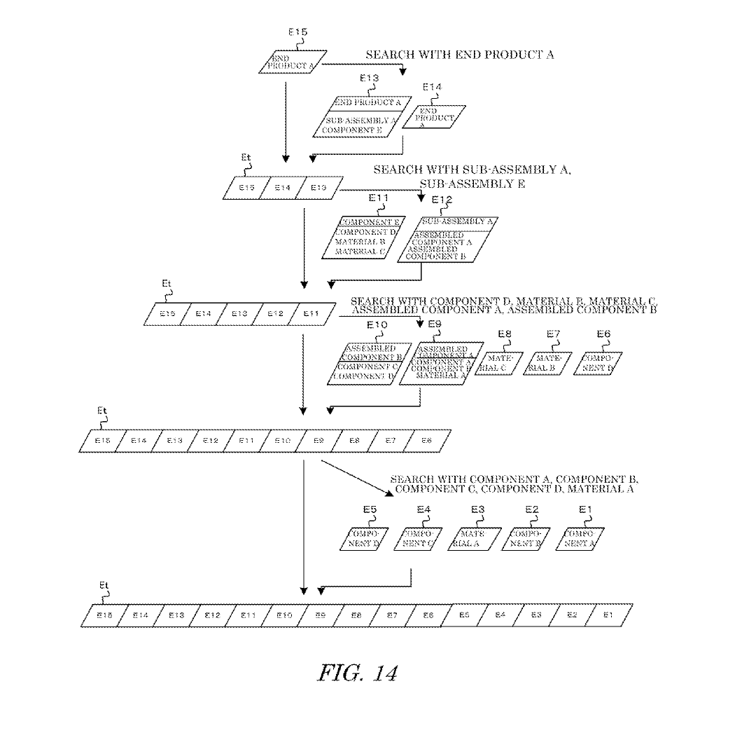

Then, as illustrated in FIG. 14, if the event information E15 generated by completion of the warehousing process is generated, the information collecting system 1 searches for another event information E by the individual identification information of the end product A included in the event information E15 and acquires the event information E14 generated by completion of the inspection process and the event information E13 generated by completion of the second sub-assembly process and generates the event tracking information Et in which the event information E13 to E15 are integrated.

The event information E13 includes the individual identification information of the sub-assembly A and the component E other than the individual identification information previously used as the search key as above. Thus, the information collecting system 1 searches for another event information E by using the individual identification information of these sub-assembly A and the component E as search keys, respectively, acquires the event information E12 generated by completion of the first sub-assembly process and the event information E11 generated by completion of the machining process and further integrates the event information E11 and 12 to the event tracking information Et.

The event information E12 includes the individual identification information of the assembled component A and the assembled component B, and the event information E11 includes the individual identification information of the component D, the material B, and the material C. The information collecting system 1 uses the individual identification information as the search key, acquires the event information E9 generated by completion of the first assembly process, the event information E10 generated by completion of the second assembly process, and event information E6 to E8 generated by completion of the receipt process of the component D, the material B, and the material C and further integrates the event information E6 to E8 and E9 and E10 to the event tracking information Et.

The event information E9 includes the individual identification information of the component A, the component B, and the material A, and the event information E10 includes the individual identification information of the component C and the component D. The information collecting system 1 uses the individual identification information as the search keys, acquires the event information E1 to E5 generated by completion of the receipt process of the component A, the component B, the material A, the component C, and the component D, and further integrates the event information E1 to E5 to the event tracking information Et.

As a result, all the event information E1 to E15 from the first manufacturing process to the last manufacturing process of the end product A is integrated into the event tracking information Et.

Moreover, assume that an end product A leaves the manufacturing process due to a fatal error determined to be not suitable for a product in the first sub-assembly process. At this time, in the first sub-assembly process, the event information E12 having the fatal error as the event type information is generated. When the event information E12 having this fatal error as the event type is generated, the information collecting system 1 searches for another event information E with the individual identification information indicating the sub-assembly A, the assembled component A, and the assembled component B included in this event information E12, acquires the event information E9 generated by completion of the first assembly process and the event information E10 generated by completion of the second assembly process and generates the event tracking information Et in which the event information E12, E9, and E10 are integrated.

The event information E9 includes the individual identification information of the component A, the component B, and the material A, and the event E10 includes the individual identification information of the component C and the component D. The information collecting system 1 uses the individual identification information as the search keys and acquires the event information E1 to E5 generated by completion of the receipt process of the component A, the component B, the material A, the component C, and the component D and further integrates the event information E1 to E5 into the event tracking information Et.

As a result, the event information E1 to E5, E9, E10, and E12 until the end product A leaves the manufacturing process due to the fatal error in the first sub-assembly process is all integrated in the event tracking information Et.

(Effect)

As described above, the information collecting system 1 is configured to include the dictionary storage unit 112 which is connected to the database 2 storing the supplementary information S having various contents and stores the dictionary defining the type of each supplementary information S to be added to the job-site data G, the searching unit 111 which searches for each supplementary information S from the database 2 in accordance with the dictionary, the reconfiguring unit 113 which reconfigures the event information E for each individual product and for each manufacturing process, and the temporary memory 114 which accumulates the event information.

Then, the searching unit 111 searches for another type of the supplementary information S using various combinations in the job-site data G included in the event information E reconfigured by the reconfiguring unit 113 and each of the added supplementary information S as the search keys, and the reconfiguring unit 113 is configured to sequentially add the supplementary information S sequentially searched by the searching unit 111 to the event information E.

Moreover, the information collecting system 1 is configured to be further provided with the tracking information generating unit 12 which generates the event tracking information Et by collecting each event information E of each of the manufacturing processes of the same individual product from the temporary memory 114 and integrating them.

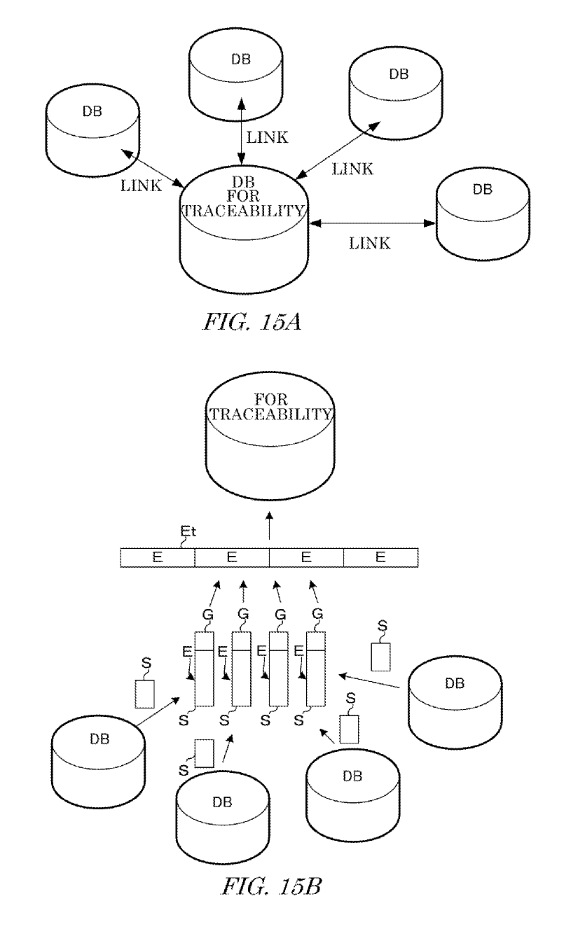

As a result, as illustrated in FIG. 15A, though the database for traceability in which a link between the databases is designed in accordance with the specification needed to be constructed in order to collect the job-site data G for each manufacturing process and the supplementary information S of each manufacturing process, and the design was difficult, in this information collecting system 1, as illustrated in FIG. 15B, the event information E is generated by using each of the databases and moreover, the event tracking information Et is generated, and thus, a link between the databases is not needed, and various types of job-site data G and the supplementary information S for each manufacturing process can be collected easily from the viewpoint of traceability. The phrase “by using each of the databases” includes a search by assuming each of the databases as the database 2 each time the event information E is generated and regular collection of the supplementary information S from each of the databases to the database 2 and generates the event information E by using the database 2 as in this embodiment.

Moreover, if the dictionary is changed in the middle, generation of the event information E and the event tracking information Et by the new dictionary starts at the time of change, and a point of change can be grasped without special history management.

### Second Embodiment

Subsequently, an embodiment of an information processing system according to a second embodiment will be described in detail. The same configuration or the same function as the first embodiment will be given the same reference numerals and detailed explanation will be omitted.

(Configuration)

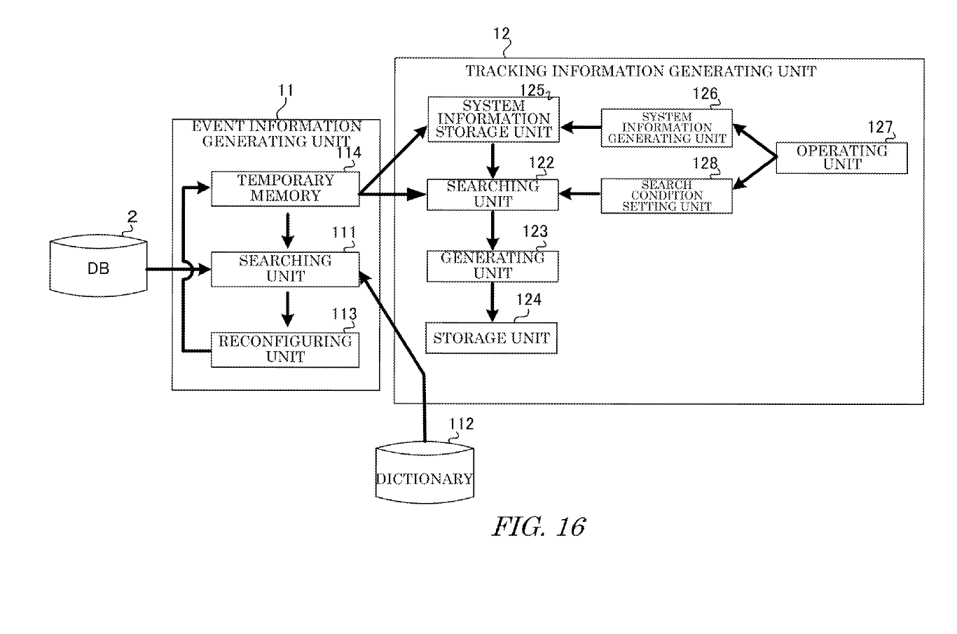

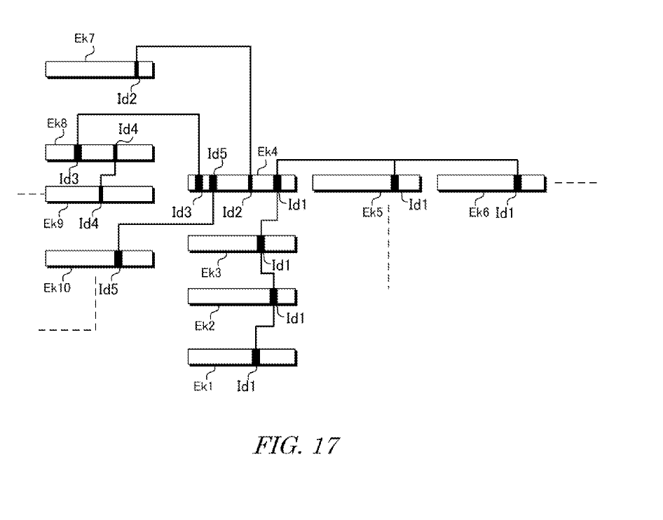

As illustrated in FIG. 16, the tracking information generating unit 12 of this information collecting system 1 includes, in addition to the searching unit 122, the generating unit 123, and the storage unit 124, a system information storage unit 125 which stores in advance system information k illustrated in FIG. 17, a system information generating unit 126 which generates the system information k, an operating unit 127 which is a man-machine interface with a user who wants the event tracking information Et, and a search condition setting unit 128 which sets a search condition of the event information E to be gathered into the event tracking information Et.

As illustrated in FIG. 17, the system information k has a plurality of pieces of event type information Ek and links each of the event type information Ek. The event type information Ek indicates a type of each event information E and defines the event information E to be included in the event tracking information Et. The link connects the event type information Ek indicating the event information E including the same individual identification information to each other and clearly shows a search key when the event information E to be included in the event tracking information Et is searched for. That is, the individual identification information owned in common by the event information E indicated by the event type information Ek connected by the link becomes a search key. However, in this information collecting system 1, the link is associated with code type information Id indicating the type of the individual identification information held in common by the both event type information Ek in order to facilitate specification of the search key.

For example, the event information E of the event type information Ek1 to Ek6 includes the same individual identification information. The type of the same individual identification information is code type information Id1. At this time, in the system information k, the event type information Ek1 to Ek6 are connected by the link, and each link is associated with the code type information Id1.

Moreover, the event information E of the event type information Ek4 includes the same individual identification information as the event information E of the event type information Ek7, the same individual identification information as the event information E of the event type information Ek8, and the same individual identification information as the event information E of the event type information Ek10. The type of the same individual identification information in the event information E of the event type information Ek4 and the event type information Ek7 is code type information Id2. Assume that the type of the same individual identification information in the event information E of the event type information Ek4 and the event type information Ek8 is code type information Id3. The type of the same individual identification information in the event information E of the event type information Ek4 and the event type information Ek10 is code type information Id5.

At this time, in the system information k, the event type information Ek4 is linked with the event type information Ek7, and the code type information Id2 is associated with the link. Moreover, in the system information k, the event type information Ek4 is linked with the event type information Ek8, and the code type information Id3 is associated with the link. Moreover, in the system information k, the event type information Ek4 is linked with the event type information Ek10, and the code type information Id5 is associated with the link.

Moreover, the event information E of the event type information Ek8 and the event type information Ek9 includes the same individual identification information. Assume that the type of the same individual identification information in the event information E of the event type information Ek8 and the event type information Ek is code type information Id4. At this time, in the system information k, the event type information Ek8 and the event type information Ek9 are linked, and the code type information Id5 is associated with the link.

This system information k is generated by the system information generating unit 126 in response to an input by the user using the operating unit 127. The operating unit 127 is a GUI interface including an input interface such as a mouse, a keyboard or a touch panel and the like and an output interface such as a monitor and the like.

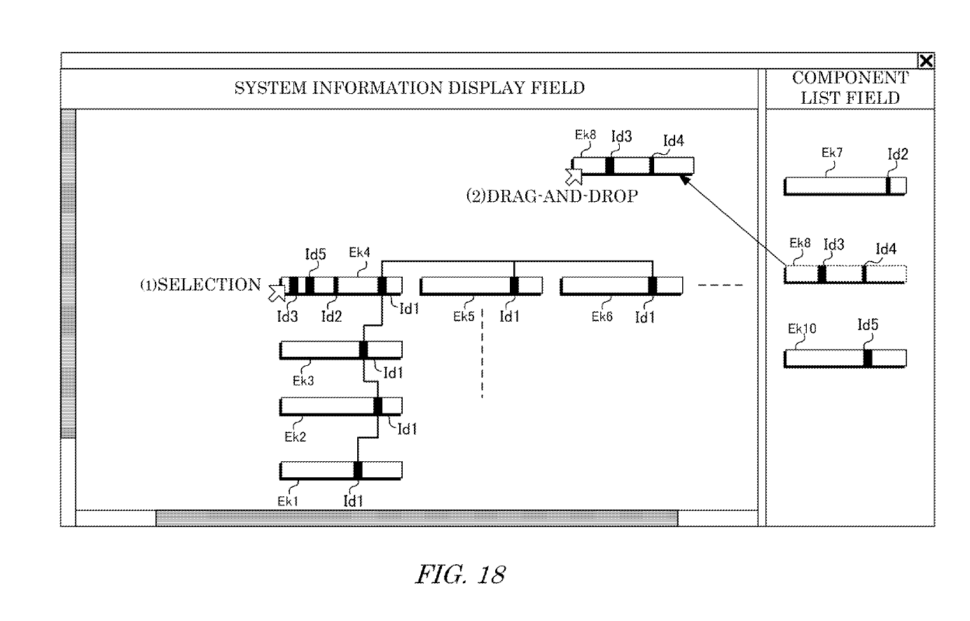

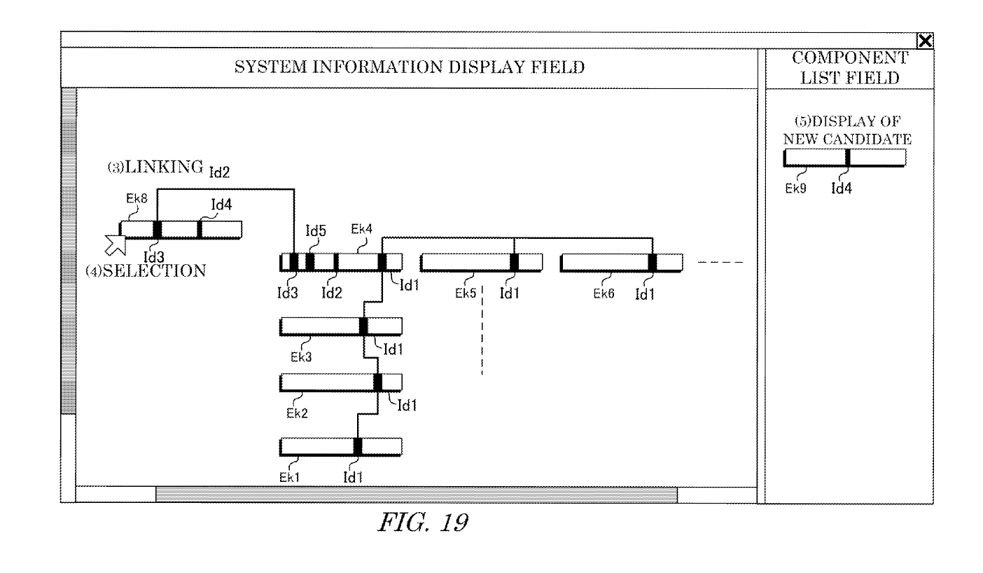

FIGS. 18 and 19 are schematic diagrams illustrating an operating screen displayed by the operating unit 127 at generation of the system information k. As illustrated in FIG. 18, the operating screen is divided into a system information display field on a left side and a component list field on a right side. In the component list field, a component object indicating candidates of the event type information Ek to be included in the system information k is displayed. In the system information display field, the system information k is displayed as a system diagram. By means of drag-and-drop of the component object from the component list field to the system information display field, the system information generating unit 126 incorporates the event type information Ek indicated by the component object subjected to the drag-and-drop into the system diagram and also includes the event type information Ek indicated by the component object with a link into the system information.

If there is no component object in the system information display field, the system information generating unit 126 displays the component object indicating all the event type information Ek on the component list field. When the component object in the system information display field is selected, the system information generating unit 126 displays the component object of the event type information Ek that can be liked with the event type information Ek indicated by the selected component object in the component list field.

The system information generating unit 126 displays the event type information Ek of the event information E having the same individual identification information as the event information E of the event type information Ek indicated by the selected component object as capable of being linked in the component list field. The system information generating unit 126 searches for the event type information Ek capable of being linked by referring to the dictionary of the dictionary storage unit 112. That is, the system information generating unit 126 searches for a model which identifies itself as the event type information Ek indicated by the selected component object from the dictionary, specifies the code type information Id described in the model and searches for another model with the code type information in the dictionary.

If the component object is subjected to drag-and-drop from the component list field to the system information list field while selecting the component object displayed in the system information display field, the system information generating unit 126 links and includes the both event type information Ek indicated by the selected component object and the component object subjected to the drag-and-drop into the system information k.

The searching unit 122 searches for the event information E to be included in the event tracking information Et by referring to the system information k. This searching unit 122 narrows the event information E to be searched by the event type information Ek included in the system information k. Moreover, the searching unit 122 specifies the individual identification information for searching for the event information E by referring to the system information k. This searching unit 122 specifies the code type information Id of the individual identification information to be acquired as a search key from the link included in the system information k.

However, the searching unit 122 determines the event type information Ek of the event information E to be subsequently searched by following the link indicated by the system information k and specifies the code type information Id of the individual identification information to be acquired as the search key from the followed link. According to the method of following the link, the search key of the event information E to be subsequently searched has been already acquired. Thus, determination on whether or not the search key for the event information E to be subsequently searched has been already acquired can be omitted, and the event information E can be collected efficiently.

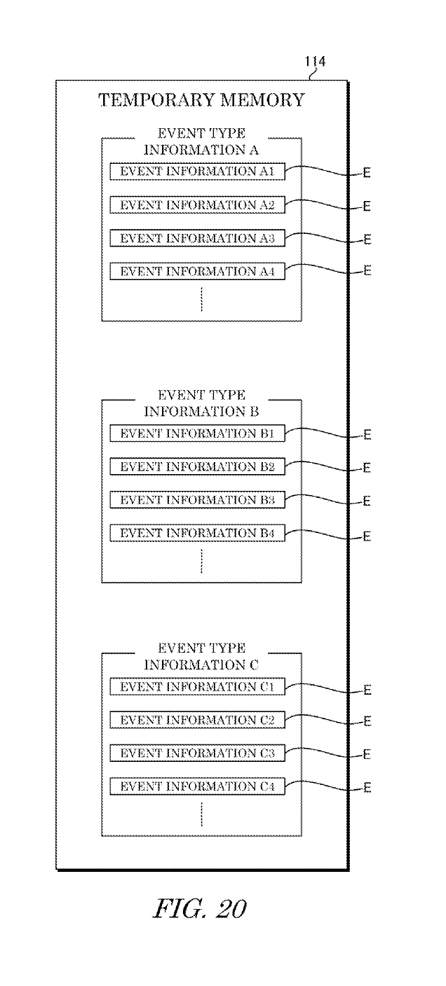

The temporary memory 114 stores the event information E grouped by the event type information Ek as illustrated in FIG. 20. The event information E has been generated on the basis of each model described in the dictionary of the dictionary storage unit 116, and each model is specified by the event type information Ek. Thus, in the temporary memory 114, the event information E is grouped by the event type information Ek specifying the model referred to at generation of the event information E and stored. For example, a folder is generated in advance for each event type information Ek, and the searching unit 122 makes a search in the folder identified by the specified event type information Ek.

The search condition setting unit 128 sets a search condition of the event information E to be gathered to the event tracking information Et in response to an operation by the user using the operating unit 127. The search condition specifies the event type information Ek which becomes a starting point and the event type information Ek which becomes an end point in following the link in the system information k and a route of the link to be followed. The searching unit 122 makes a search in accordance with the search condition set by the search condition setting unit 128. Depending on the search condition, the route might branch, and a plurality of end points might be set. Moreover, the search condition might include a generation period of the event information E.

Since the event type information Ek which becomes a start point, the event type information Ek which becomes an end point in following the link, and the route of the link to be followed are specified, not only the event tracking information Et following a manufacturing process but the straightforward event tracking information Et which is necessary and sufficient for a specific purpose such as tracking of a product using an abnormal component is generated. The presence of the system information k has already achieved the purpose and by generating the system information k in accordance with the operation by the user, the event tracking information Et matching the specific purpose desired by the user can be generated, but by further setting a part of the system information k as a route by the search condition, a labor of creating the system information k can be omitted.

As a method of specifying the search condition, for example, specification may be made by surrounding a part of a range of a system diagram acquired by visualizing the system information k by a mouse operation or a proposition may be specified. The proposition is extraction of all the products manufactured by a specific component, for example. In this exemplified proposition, the event type information Ek which becomes a start point is determined by a first condition that the product is manufactured by the specific component. Moreover, the event type information Ek which becomes an end point is determined by a second condition of extraction of all the products. Then, a route of a link connecting the start point and the end point is determined.

(Operation)

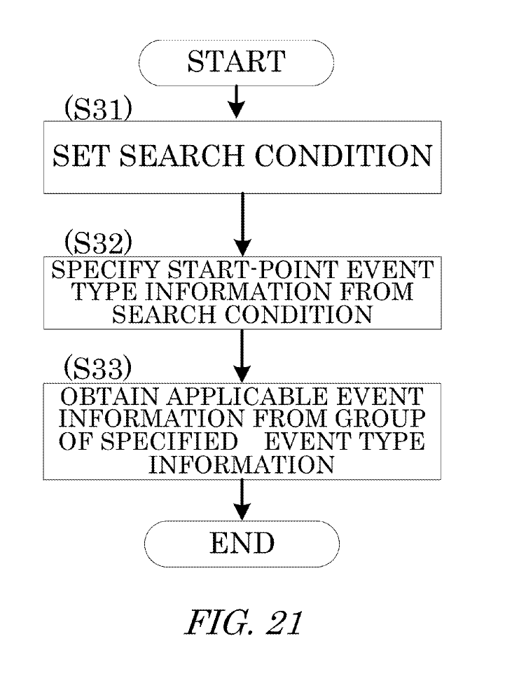

An operation for generating the event tracking information Et by such information collecting system 1 will be described. FIG. 21 is a flowchart illustrating an acquiring operation of the event information E which becomes a start point. First, the user sets a search condition by using the operating unit 127 (Step S31). The searching unit 122 starts generation of the event tracking information Et by the setting of this search condition.

The searching unit 122 specifies the event type information Ek which becomes the start point from the search condition (Step S32) and acquires the applicable event information E from a group of the event type information Ek (Step S33). If the search condition has no particular limitation, each event information E is acquired from the group of the event type information Ek and each is made a core of the event tracking information Et. If a period is set in the search condition, time and date of generation involved in the job-site data G and the set period are compared, and the applicable event information E is acquired as a start point of the event tracking information Et.

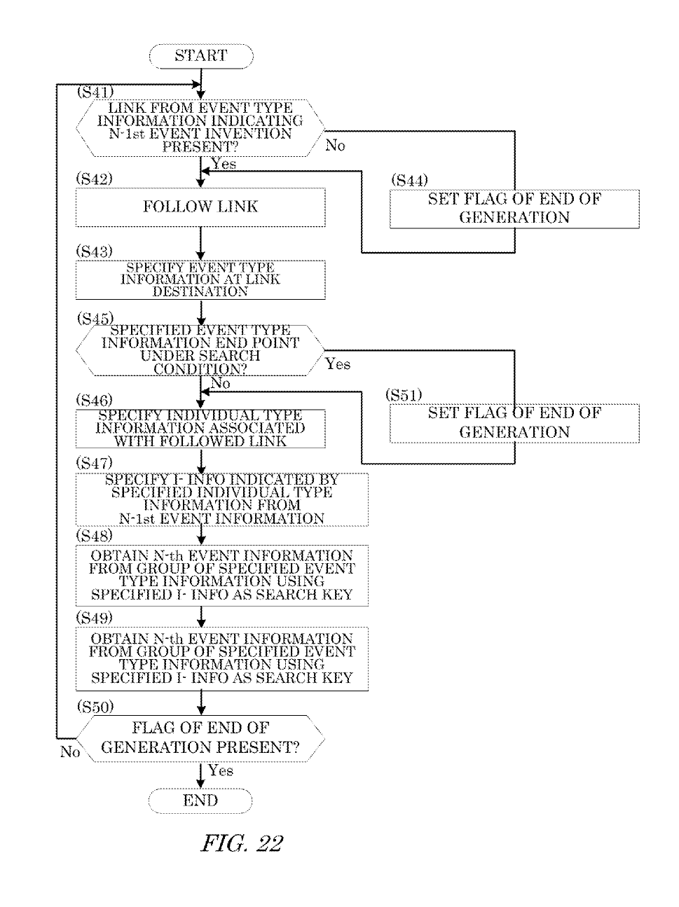

Subsequently, an operation of searching for the N-th event information E and adding it to the event tracking information Et will be described on the basis of FIG. 22. Reference character N is an integer of 2 or more, and the N-th event information E is those other than the first event information E to be added to the event tracking information Et.

First, when addition of the N−1st event information E to the event tracking information Et is finished, the searching unit 122 determines presence of a link extending from the event type information Ek indicating the N−1st event information E in the system information k (Step S41). If there is a link (Step S41, Yes), the link is followed by one (Step S42), and the event type information Ek at the link destination is specified (Step S43). If there are a plurality of links in the event type information Ek indicating the N−1st event information E in the system information k, the route indicated by the search condition is depended upon. If no route is indicated in the search condition, all the links are followed.

If no link extends from the event type information Ek indicating the N−1st event information E (Step S41, No), the searching unit 122 sets a flag of end of generation (Step S44). Moreover, when the event type information Ek indicating the N-th event information E is specified, the searching unit 122 determines whether or not the event type information Ek is an end point by referring to the search condition (Step S45). If the event type information Ek indicating the N-th event information E is the end point (Step S45, Yes), the searching unit 122 sets a flag of end of generation (Step S51).

Then, the searching unit 122 specifies the code type information Id associated with the followed link (Step S46) and specifies the individual identification information indicated by the specified code type information Id from the N−1st event information E (Step S47). The searching unit 122 acquires the N-th event information E from the group of the event type information Ek using the specified individual identification information as a search key (Step S48). The generating unit 123 adds the event information E acquired by the searching unit 122 to the event tracking information Et (Step S49).

When the N-th event information E is added to the event tracking information Et, the searching unit 122 determines whether or not there is a flag of end of generation (Step S50). If there is a flag of end of generation (Step S50, Yes), the searching unit 122 finishes generation of the event tracking information Et. On the other hand, if there is no flag of end of generation (Step S50, No), the searching unit 122 returns to Step S41 and executes additional processing of the subsequent event information E.

(Action)

A specific example of generation of the event tracking information Et by this information collecting system 1 will be illustrated. In FIG. 17, the event type information Ek1 indicates the event information E generated when an abnormal product is generated in an assembling process. The event type information Ek6 indicates the event information E generated by the warehousing of a product. The search condition set by the user by using the operating unit 127 is assumed to be a search for the event tracking information Et of a product in which abnormality was generated in the assembling process and which has been already warehoused.

At this time, the searching unit 122 acquires the event information E from the group of the event type information Ek1 and makes it a core of the event tracking information Et. Moreover, the searching unit 122 acquires the individual identification information of the code type information Id1 which is present in the event information E.

Subsequently, the searching unit 122 follows the link extending from the event type information Ek1 and specifies event type information Ek2. The searching unit 122 searches for the event information E having the individual identification information of the already acquired code type information Id1 from the group of the specified event type information Ek2 and adds the applicable event information E to the event tracking information Et.

Moreover, the searching unit 122 follows the link extending from the event type information Ek2 and specifies event type information Ek3. The searching unit 122 searches for the event information E having the individual identification information of the already acquired code type information Id1 from the group of the specified event type information Ek3 and adds the applicable event information E to the event tracking information Et.

Moreover, the searching unit 122 follows the link extending from the event type information Ek3 and specifies event type information Ek4. The searching unit 122 searches for the event information E having the individual identification information of the already acquired code type information Id1 from the group of the specified event type information Ek4 and adds the applicable event information E to the event tracking information Et.

Four links extend from the event type information Ek4. The search condition specifies the link extending from the code type information Id1 as a route. Therefore, the searching unit 122 follows the link extending from the event type information Ek4 and specifies event type information Ek5. The searching unit 122 searches for the event information E having the individual identification information of the already acquired code type information Id1 from the group of the specified event type information Ek5 and adds the applicable event information E to the event tracking information Et.

Moreover, the searching unit 122 follows the link extending from the event type information Ek5 and specifies event type information Ek6. The searching unit 122 searches for the event information E having the individual identification information of the already acquired code type information Id1 from the group of the specified event type information Ek6 and adds the applicable event information E to the event tracking information Et.

As a result, the information collecting system 1 generates the event tracking information Et relating to the product which has been warehoused even though abnormality generated in the product during assembling and can provide it to the user.

Moreover, another specific example of generation of the event tracking information Et by this information collecting system 1 will be illustrated. In FIG. 17, the event type information Ek7 indicates the event information E generated by warehousing of the B component of the type A used in the assembling process. The event type information Ek6 indicates the event information E generated by the warehousing of the product. The search condition set by the user by using the operating unit 127 is assumed to be a search for the event tracking information Et of the product having been already assembled by using the B component of the type A and warehoused.

At this time, the searching unit 122 acquires the event information E whose individual identification information indicates the B component from the group of the event type information Ek7 and makes it a core of the event tracking information Et. Moreover, the searching unit 122 acquires the individual identification information of the code type information Id2 indicating the type A of the component which is present in the event information E.

Subsequently, the searching unit 122 follows the link extending from the event type information Ek7 and specifies the event type information Ek4. The searching unit 122 searches for the event information E having the individual identification information of the already acquired code type information Id2 from the group of the specified event type information Ek4 and adds the applicable event information E to the event tracking information Et.

Four links extend from the event type information Ek4. The search condition specifies the link extending from the code type information Id1 as a route. Therefore, the searching unit 122 follows the link extending from the event type information Ek4 and specifies event type information Ek5. Moreover, the searching unit 122 acquires the individual identification information of the code type information Id1 from the event information E acquired by the search based on the event type information Ek.

Then, the searching unit 122 searches for the event information E having the individual identification information of the already acquired code type information Id1 from the group of the specified event type information Ek5 and adds the applicable event information E to the event tracking information Et.

Moreover, the searching unit 122 follows the link extending from the event type information Ek5 and specifies event type information Ek6. The searching unit 122 searches for the event information E having the individual identification information of the already acquired code type information Id1 from the group of the specified event type information Ek6 and adds the applicable event information E to the event tracking information Et.

As a result, the information collecting system 1 generates the event tracking information Et relating to the product which has been warehoused even though the component B having a defect or the like was used and can provide it to the user.

(Effect)

As described above, in this information collecting system 1, the event type information Ek of the event information E to be integrated into the event tracking information Et is stored in the system information storage unit 125. Then, the event information E corresponding to the event type information Ek stored in the system information storage unit 125 in each event information of each manufacturing process of the same individual product is collected from the temporary memory 114 and gathered and integrated into the event tracking information Et.

As a result, it is not necessary to search all the event information E. Thus, a processing burden of the computer for generating the event tracking information Et is drastically reduced, and the event tracking information Et including the event information E which is necessary and sufficient for the user can be rapidly generated. Moreover, by examining the event type information Ek to be stored in the system information storage unit 125, not only the event tracking information Et simply following the manufacturing process but also the event tracking information Et which is necessary and sufficient and straightforward for the specific purpose such as tracking of the product using an abnormal component or the like can be provided. That is, the event tracking information Et which satisfies the specific purpose desired by the user can be freely generated.

Moreover, in the system information storage unit 125, the system information k with which the event type information Et of the event information E having the same individual identification information is linked is stored, and the tracking information generating unit 12 is configured to specify the event type information Et of the event information E to be collected subsequently by following the link and to collect the event information to be collected subsequently by using the same individual identification information as a search key.

According to this method of following the link, the search key of the event information E to be searched subsequently has been already acquired without fail. Thus, absence of the search key and the like does not have to be considered, and the event information E can be collected reliably and efficiently. Moreover, the processing burden of the computer for generating the event tracking information Et can be further reduced, and the event tracking information Et including the event information E which is necessary and sufficient for the user can be generated more rapidly.

Moreover, the temporary memory 114 stores the event information E for each event type information Ek, and the tracking information generating unit 12 is configured to search only for the event information E corresponding to the specified event type information Ek. As a result, since the group of the event information E to be searched can be easily detected, the event tracking information Et desired by the user can be provided more rapidly.

Moreover, the display screen for generating the link of the event type information Et is displayed, the operating unit 127 for operating the display screen is further provided, and the system information k is configured to be generated in response to the operation by the user. As a result, since the various types of system information k can be freely created, the user can set the event information E to be included in the event tracking information Et freely in accordance with the purpose, and convenience of the event tracking information Et is improved.

### REFERENCE SIGNS LIST

1 information collecting system
11 event information generating unit
111 searching unit
112 dictionary storage unit
113 reconfiguring unit
114 temporary memory
12 tracking information generating unit
121 start-point event monitoring unit
122 searching unit
123 generating unit
124 storage unit
125 system information storage unit
126 system information generating unit
127 operating unit
128 search condition setting unit
2 database
200a data generating apparatus
200b data generating apparatus
200c data generating apparatus
G job-site data
S supplementary information
E event information
Et event tracking information
Ek event type information
k system information
Id code type information
N network

1. An information collecting system connected to each of data generating apparatuses which generates job-site data of each manufacturing process for each individual product via a network, comprising:
a first storage storing a dictionary defining a type of each of supplementary information to be added to the job-site data;
a database storing the supplementary information having various contents;
a searching section searching for each of the supplementary information from the database in accordance with the dictionary;
a reconfiguring section reconfiguring event information of each of the individual products and each of the manufacturing processes by adding each of the searched supplementary information to the job-site data and; and
a second storage accumulating the event information, wherein
the searching section makes the search for the supplementary information by using a combination according to a type defined in the dictionary in the job-site data included in the event information reconfigured by the reconfiguring section and each of the added supplementary information as a search key;
the reconfiguring section sequentially adds the supplementary information sequentially searched by the searching section to the event information; and
a tracking information generating section is further provided which generates event tracking information in which each of event information of each manufacturing process of the same individual product is collected from the second storage and integrated.

2. The information collecting system according to claim 1, further comprising:
a third storage storing type information of the event information to be integrated into the event tracking information, wherein
the tracking information generating section collects the event information indicated by the type information stored in the third storage from the second storage and integrates the same.

3. The information collecting system according to claim 2, wherein
in the dictionary stored by the first storage, a type indicating individual identification information of a component or a material used in a product in a manufacturing process from which the event information originates is defined as supplementary information to be added to the job-site data;
the reconfiguring section adds the individual identification information to the event information; and
the tracking information generating section repeats collection of the event information by using the individual identification information as a search key and collection of the event information by using the individual identification information similarly included in the collected event information as the search key and collects each of the event information of each manufacturing process of the same individual product.

4. The information collecting system according to claim 3, wherein
the third storage stores the type information of the event information having the same individual identification information in association by a link; and
the tracking information generating section specifies the type information of the event information to be subsequently collected by following the link and collects the event information to be subsequently collected by using the same individual identification information as a search key.

5. The information collecting system according to claim 4, wherein
the second storage stores the event information for each of the type information; and
the tracking information generating section uses only the event information corresponding to the specified type information as a search target.

6. The information collecting system according to claim 1, further comprising:
a display displaying a screen for selecting the type information to be stored in the third storage; and
an operating section for operating the display screen.

7. An information collecting method of an information collecting system connected to each of data generating apparatuses which generates job-site data of each manufacturing process for each individual product via a network,
the information collecting system including:
a first storage storing a dictionary defining a type of each of supplementary information to be added to the job-site data;
a database storing the supplementary information having various contents; and
a second storage, comprising:
a searching step of searching each of the supplementary information from the database in accordance with the dictionary;
an event information generating step of adding each of the searched supplementary information to the job-site data and reconfiguring event information of each individual product and each manufacturing process; and
a storage step of accumulating the event information in the second storage are executed, wherein
in the searching step, a search is made for the supplementary information by using a combination according to a type defined in the dictionary in the job-site data included in the event information reconfigured in the event information generating step and each of the added supplementary information as a search key;
in the event information generating step, the supplementary information sequentially searched by the searching section is sequentially added to the event information; and
event tracking information in which each of the event information of each manufacturing process of the same individual product is collected from the storage and integrated is further executed.

8. The information collecting method according to claim 7, wherein
the information collecting system further includes a third storage storing type information of the event information to be integrated into the event tracking information; and
the tracking information generating step collects the event information indicated by the type information stored in the third storage from the second storage and integrates the same.

9. The information collecting method according to claim 8, wherein
in the dictionary stored in the first storage, the type indicating the individual identification information of a component or a material used in a product in the manufacturing process from which the event information originates is defined as the supplementary information to be added to the job-site data;
in the event information generating step, the individual identification information is added to the event information; and
in the tracking information generating step, collection of the event information by using the individual identification information as a search key and collection of the event information by using the individual identification information similarly included in the collected event information as the search key are repeated so as to collect each of the event information of each manufacturing process of the same individual product.

10. The information collecting method according to claim 9, wherein
the third storage stores the type information of the event information having the same individual identification information in association by a link; and
the tracking information generating step specifies the type information of the event information to be subsequently collected by following the link and collects the event information to be subsequently collected by using the same individual identification information as a search key.

11. The information collecting method according to claim 10, wherein
the second storage stores the event information for each of the type information; and
the tracking information generating step uses only the event information corresponding to the specified type information as a search target.

12. The information collecting method according to claim 7, wherein
a display screen for selecting the type information to be stored in the third storage is displayed on the display screen; and the type information is stored in the third storage in accordance with an operation on the display screen.

13. A computer-accessible storage medium storage recording a program, which allows an information collecting system connected to each of data generating apparatuses which generates job-site data of each manufacturing process for each individual product via a network, including:
a first storage storing a dictionary defining a type of each of supplementary information to be added to the job-site data;
a database storing the supplementary information having various contents; and
a second storage, to execute:
a searching step of searching each of the supplementary information from the database in accordance with the dictionary;
an event information generating step of adding each of the searched supplementary information to the job-site data and of reconfiguring event information of each individual product and each manufacturing process; and
a storage step of accumulating the event information in the second storage, wherein
in the searching step, a search is made for the supplementary information by using a combination according to a type defined in the dictionary in the job-site data included in the event information reconfigured in the event information generating step and each of the added supplementary information as a search key;
in the event information generating step, the supplementary information sequentially searched by the searching section is sequentially added to the event information; and
a tracking information generating step of generating the event tracking information in which each of the event information of each manufacturing process of the same individual product is collected from the storage and integrated is further executed.

14. The storage medium according to claim 13, wherein
the information collecting system further includes a third storage storing type information of the event information to be integrated into the event tracking information; and
the tracking information generating step collects the event information indicated by the type information stored in the third storage from the second storage and integrates the same.

15. The storage medium according to claim 14, wherein
in the dictionary stored in the first storage, the type indicating the individual identification information of a component or a material used in a product in the manufacturing process from which the event information originates is defined as the supplementary information to be added to the job-site data;
in the event information generating step, the individual identification information is added to the event information; and
in the tracking information generating step, collection of the event information by using the individual identification information as a search key and collection of the event information by using the individual identification information similarly included in the collected event information as the search key are repeated so as to collect each of the event information of each manufacturing process of the same individual product.

16. The storage medium according to claim 15, wherein
the third storage stores the type information of the event information having the same individual identification information in association by a link; and
the tracking information generating step specifies the type information of the event information to be subsequently collected by following the link and collects the event information to be subsequently collected by using the same individual identification information as a search key.

17. The storage medium according to claim 16, wherein
the second storage stores the event information for each of the type information; and
the tracking information generating step uses only the event information corresponding to the specified type information as a search target.

18. The storage medium according to claim 13, wherein
a display screen for selecting the type information to be stored in the third storage is displayed on a display screen and the type information is stored in the third storage in accordance with an operation on the display screen.
